(19) United States
(12) Patent Application Publication
(10) Pub. No.: US 2026/0184552 A1
(43) Pub. Date: Jul. 2, 2026

(54) Handgrip Corkscrew

(71) Applicant: Carnot Leal Nogueira, Boulder, CO (US)

(72) Inventor: Carnot Leal Nogueira, Boulder, CO (US)

(21) Appl. No.: 19/004,963

(22) Filed: Dec. 30, 2024

(51) Int. Cl. B67B 7/04

(52) U.S. Cl. CPC B67B 7/0441

(57) ABSTRACT

A corkscrew for opening bottles with natural or synthetic corks that uses handgrip strength is provided. Handgrip force is applied to a hinged lever that transmits the force to the cork along its axial direction to pull-out the cork from the bottle. The geometry of the lever is such that the applied handgrip force is increased when transmitted to the cork pull-out direction. In the active state, the lever transmits the handgrip force to a saw-toothed extractor that engages a rack with a sequence of teeth, e.g., conical frusta, along its length and pulls-out the cork from the bottle, whereas in the inactive state, the rack, also equipped with a handle and a helical metal rod, can freely translate and rotate along its axis allowing the helical metal rod to be inserted into the cork. The corkscrew allows corks to be easily pulled-out from bottles with one hand.

### FIELD OF THE INVENTION

This invention relates generally to the field of corkscrews to open bottles of wine or other beverages closed with natural or synthetic corks. More particularly, it refers to methods of opening bottles closed with corks using handgrip force.

### BACKGROUND OF THE INVENTION

Bottles of wine and other beverages, very frequently, use natural or synthetic corks to seal the liquid contents inside the bottle. The corks usually have cylindrical shape and are compressed upon insertion into the neck of the bottle. The removal of the corks requires the application of a force in the pull-out direction. The force to extract the cork is usually applied to a helical metal rod (sometimes referred to as worm) inserted into the cork by pressing and twisting against its center. After the insertion of the helical metal rod into the cork, the application of the force required to pull-out the cork is the critical step to open the bottle and several different approaches have been used.

The traditional basic T-shaped corkscrew, also called twist and pull corkscrew, after the helical metal rod is inserted into the cork, requires not only force, but also dexterity to extract the cork. With one hand, force has to be applied to the corkscrew in the pull-out direction, while with the other hand, the bottle has to be firmly held. Sometimes, while the pull-out force is applied and the cork finally suddenly detaches from the bottle neck, the heel (bottom) of the bottle hits the table or escapes from the hand that was holding it and breaks. The traditional T-shaped corkscrew is, therefore, not only hard to use, but can also lead to accidents.

The waiter's corkscrew is equipped with one or more hinged metal levers. To open a bottle with the waiter's corkscrew, after the insertion of the helical metal rod into the cork, the hinged metal levers are applied to the mouth of the bottle while force is exerted in the handle of the corkscrew to extract the cork. The process requires some dexterity, because while the force is applied to the handle of the corkscrew with one hand in a circular arc movement, the bottle tends to rotate and has to be held in place with the other hand. If the bottle escapes from the hand that is holding it, it may fall and break. In addition, while pulling-out the cork, the application of the metal lever to the mouth of the glass bottle can break small pieces of the glass, leading to a dangerous situation where pieces of glass can be mixed to the wine or other beverage.

The wing corkscrew has two levers that, after the helical metal rod is inserted into the cork, have to be pressed simultaneously with both hands in order to extract the cork. Since both hands are used to press the levers, the bottle has to be safely supported while the levers simultaneously move and the cork pulls-out. The process can be cumbersome and requires some dexterity, both hands have to be used to move the levers and the bottle, if not firmly supported, can fall.

The Ah-So cork puller with parallel blades, also referred to as twin-prong cork puller, is equipped with two parallel metal blades to be inserted between the cork and the neck of the bottle. After the insertion of the blades, the Ah-So cork puller is twisted and pulled-out to detach the cork cylindrical lateral surface from the inner surface of the bottle neck and extract the cork. This type of corkscrew is used to older wines with fragile corks, it requires strength to pull-out the cork and has the same disadvantages of the above mentioned traditional basic T-shaped corkscrew: during the pull-out force application, the cork can suddenly detach from the bottle neck and the heel of the bottle can hit the table or other object and break.

All types of corkscrews mentioned above rely on the application of mechanical force to extract the cork after the insertion of the helical metal rod or the twin prongs. For all of them, the application of the force to pull-out the cork requires some ability and can be cumbersome and lead to accidents, in particular when the cork suddenly detaches from the bottle. With the sudden detachment of the cork from the bottle neck, the bottle can move and hit an object and break or fall.

There exists a need, therefore, for a corkscrew that can be easily and safely operated and whose operation is not susceptible to causing accidents.

### SUMMARY OF THE INVENTION

Presented herein is an innovative method to easily open a bottle of wine with a corkscrew equipped with a lever that transmits the force exerted by a hand grip to the pull-out direction of the cork. The method takes advantage of the very natural and ergonomic movement of a hand grasping, gripping, to open a bottle of wine or other beverage, pulling-out the cork, with only one hand. The handgrip force is transmitted to the axial direction of the cylindrical cork (the pull-out direction) using a hinged lever. By repeatedly pressing the lever arm with one hand, by repeatedly closing and opening the hand, the cork is extracted from the neck of the bottle in the pull-out direction.

As specified in the preferred embodiment of the invention, the hinged lever transmits the handgrip force to the axial direction of the cylindrical cork in the pull-out direction using a saw-toothed extractor that engages a rack equipped with a series of aligned teeth, such as conical frusta. The rack also has a helical metal rod at one of its ends and a handle at the other end. The handle and the helical metal rod allow the cork to be screwed and properly fixed to the rack. When the lever is activated by the handgrip force, the teeth of the saw-toothed extractor contact and engage the rack axisymmetric teeth and gain purchase as the lever rotates around its hinge. After the helical metal rod is inserted in the cork, the movement of the rack in the pull-out direction extracts the cork. The repeated application of the handgrip force to the hinged lever slowly forces the cork in the pull-out direction. When no force is applied to the lever arm, a torsion spring restores it to the inactive position, disengaging the saw-toothed extractor. In the inactive position, the rack, which is assembled in the top part of a tubular body that also has a frame and an annular bottom that fits a bottle neck, can move along its axis (in translation) and also rotate.

According to another preferred embodiment of the invention, more than one lever and more than one saw-toothed extractor are used to transmit the handgrip force to the pull-out direction and extract the cork. If two levers are used, they can be positioned opposite to each other in such a way that when the handgrip force is applied both levers are activated and transmit force to the saw-toothed extractor and to the rack.

According to yet another embodiment of the invention, the lever applies the pull-out force directly to the rack and no saw-toothed extractor is required.

Other characteristics, advantages and features of the invention will become apparent from the figures and detailed description in the sections below, which relate to an exemplary embodiment. The embodiment described is to be understood as an example and an indication of one of the possible embodiments, not as a limitation.

The preferred embodiment of the invention here disclosed will be referred to in detail using the figures described below. Figures and detailed description in the sections below are provided here as non-limiting examples.

### BRIEF DESCRIPTION OF DRAWINGS

The appended drawings, which constitute a part of and are incorporated in this specification, illustrate aspects of the invention and together with their description, explain some principles of the invention. Reference characters used therein indicate parts throughout the drawings. The drawings are also intended to facilitate the description of the invention.

FIG. 1 is an elevation view of the tubular body of the corkscrew with a lower circular section dimensioned to fit the neck of a bottle and the upper part with a chamber to guide the rack and to house the saw-toothed extractor;

FIG. 2 is an elevation view the interior of the cover of the upper part of the tubular body dimensioned to fit the tubular body, guide the rack, and house the saw-toothed extractor in a chamber;

FIG. 3 is an elevation view of the exterior side of the cover of the upper part of the tubular body depicted in FIG. 2;

FIG. 4 is a perspective view of the saw-toothed extractor;

FIG. 5 is a perspective view of a cross-section of the saw-toothed extractor represented in FIG. 4 showing the cylindrical connection (pin) between the side walls of the saw-toothed extractor;

FIG. 6 is an elevation view of the cylindrical rack with a helical metal rod at its lower part, a handle at the upper part, and a sequence of teeth (conical frusta) along its length to allow the engagement of the saw-toothed extractor;

FIG. 7 is an elevation view of the lever with a cylindrical hole, an upper slot to fit the cylindrical connection of the saw-toothed extractor, and a second slot to house the coils of a torsion spring;

FIG. 8 is a perspective view of the torsion spring;

FIG. 9 is an elevation view of the corkscrew without the cover and with the lever arm in the lower position showing the saw-toothed extractor engaging the teeth (conical frusta) on the rack;

FIG. 10 is an elevation view of the corkscrew without the cover and with the lever arm in the upper position showing the saw-toothed extractor disengaged from the teeth (conical frusta) on the rack allowing the rack to rotate and translate along its axis;

FIG. 11 is a perspective view of the corkscrew without the cover and with the lever arm in the lower position showing the saw-toothed extractor engaging the teeth (conical frusta) on the rack;

FIG. 12 is a perspective view of the corkscrew without the cover and with the lever arm in the upper position showing the saw-toothed extractor disengaged from the teeth (conical frusta) on the rack allowing the rack to rotate and translate along its axis;

FIG. 13 is an elevation view of the corkscrew with the cover and with the lever arm in the upper position allowing the rack to rotate and translate along the vertical axis of the tubular body.

### DETAILED DESCRIPTION OF THE INVENTION

The invention can be understood by reference to the following detailed description, reference to figures, examples, and claims, and also by reference to the previous description. The invention is not limited to the specific parts, connections and embodiments herein described. The terminology used is for the purpose of describing particular aspects only and is not intended to be limiting. It will be apparent that some of the benefits of the present invention can be obtained by selecting only some of the features of the present invention without utilizing some other features. The following description is provided as illustrative of the principles of the present invention and not in limitation thereof.

In the description below, singular forms “the,” “a” and “an” include plural referents unless the context clearly dictates otherwise. For example, reference to a “saw-toothed extractor” includes aspects having two or more extractors unless the context clearly indicates otherwise, reference to a “lever” includes aspects having two or more levers unless the context clearly indicates otherwise. Terms used herein, such as “for example”, are not meant to show preference for a particular embodiment over another embodiment, but rather to explain a specific aspect presented.

Presented herein is a handgrip corkscrew that allows the extraction of synthetic or natural corks from bottles of wine and other beverages using handgrip force applied by one hand on a lever.

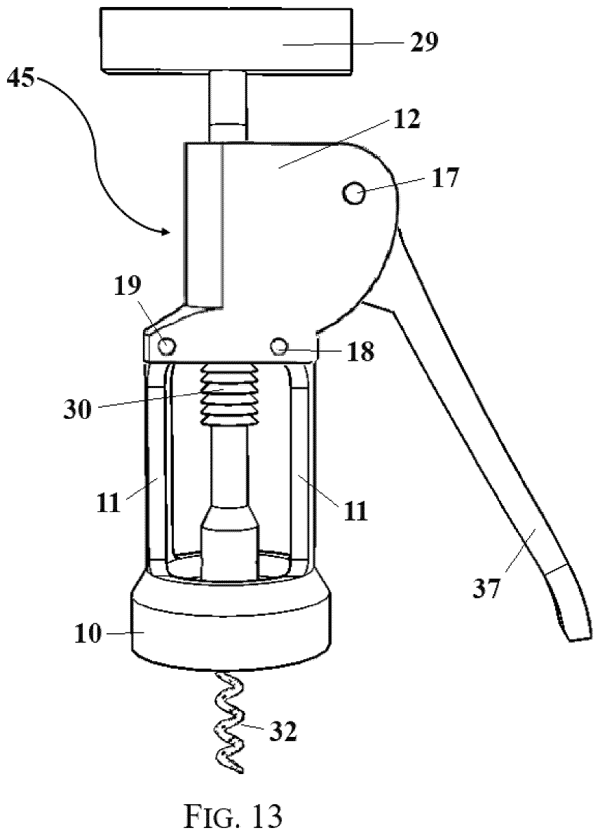

With reference to FIGS. 9-12, the handgrip corkscrew 41 (FIGS. 9), 42 (FIGS. 10), 43 (FIGS. 11), 44 (FIG. 12) comprises at least a lever 33 (FIG. 7) hinged at its top part 34 that allows the application of handgrip force F_{HAND} 42, 44 along its length 37 and transmits the applied force to a saw-toothed extractor 20 (FIG. 4, FIG. 5) with a pin 27. The saw-toothed extractor 20 engages a rack 28 (FIG. 6) along its length with teeth, the frustoconical length 30. The rack 28 (FIG. 6) is equipped with a handle 29 and a helical metal rod 32 that can be screwed into any synthetic or natural cork. The handgrip force F_{HAND} 42, 44 applied to lever arm 37 is transmitted to the pin 27 in the saw-toothed extractor 20 inserted in a slot 35 in the lever arm 37. The teeth 26 in saw-toothed extractor 20, as the hinged lever 33 moves around the hinge 34 with the applied handgrip force F_{HAND} 42, 44 along arc AB, from A to B (FIG. 10, FIG. 12), gain purchase as they move towards the frustoconical length 30 of the rack 28 and transmit the applied force F_{HAND} 42, 44 to the cork pull-out direction F_{CORK} 42, 44. Lever 33 rotates describing arc AB (FIG. 10) in the same plane that contains the axis of the rack 28 (plane of the paper in FIG. 10) and the hinge 34 axis is normal (perpendicular) to that plane.

The force magnitude in the rack 28 axial direction at the lever slot 35, where the saw-toothed extractor pin 27 is inserted, is proportional to the ratio between lengths l₁/l₂ of the lever 33 (FIG. 7). If, for example, l₁ and l₂ have dimensions equal to 2½ in (63.50 mm) and ½ in (12.70 mm), respectively, the ratio l₁/l₂ is 5 (five) and the force at the lever slot 35 is 5 (five) times the handgrip force F_{HAND} 42, 44 applied at the lever arm length 37. Force F_{CORK} 42, 44 applied to the cork along the pull-out direction of the rack 28, 42, 44 axis is proportional to the ratio (l₁/l₂) multiplied by the magnitude of force F_{HAND}: (l₁/l₂) F_{HAND} 33, 42, 44.

Rack 28, lever 33, and saw-toothed extractor 20 are assembled in a tubular body 1. Tubular body 1, on its top portion, has a cylindrical surface 2 that fits the external diameter of the rack 28, and a chamber 3 (with an opening to the rack) that houses the saw-toothed extractor 20 and the lever 33. The lower part of the tubular body has a frame with two vertical members 11 connected to a frustoconical shape and an annular base 10 that fits the neck of the bottle. Chamber 3 that houses the saw-toothed extractor 20 has two slots 4, 5 dimensioned in a way that when the saw-toothed extractor 20 is in the lower position the teeth on its back side 23, 25 (on the face opposed to the saw-toothed face) are perfectly and fully inserted in the slots 4, 5 and the saw-toothed extractor 20 remains disengaged from the frustoconical length 30 of the rack 28.

When the lever arm 37 (FIG. 7) is lifted (position A, FIG. 10), the saw-toothed extractor 20 remains in the lower position inside the chamber, in the disengaged position 42 (FIGS. 10), 44 (FIG. 12). Teeth 23, 25 on the back side of the saw-toothed extractor 20 remain fully inserted in chamber slots 4, 5 and rack 30 can move in translation along its axis and in rotation.

When the lever arm 37 (FIG. 7) moves from the lifted to the lowered position (position B, FIG. 10), the saw-toothed extractor 20 is forced to move upwards inside the chamber because its pin 27 is inserted in the lever slot 35. With the movement of the lever 33, the saw-toothed extractor 20 is simultaneously forced to move towards the frustoconical length of the rack 30, because with the upward movement teeth 23, 25 on the back of the saw-toothed extractor 20 are forced to move out of chamber slots 4, 5.

The saw-toothed extractor 20, as the lever arm 37 moves from the lifted position 42 (FIG. 10) to the lowered position 41 (FIG. 9), describing arc AB, from A to B, 42 (FIGS. 10), 44 (FIG. 12), moves inside the chamber simultaneously towards the rack 28 and upwards, in the pull-out direction, engaging the frustoconical length of the rack 30 and forcing the helical metal rod 32 (previously inserted into the cork) in the pull-out direction.

Referring to FIG. 10 and FIG. 12 (42 and 44, respectively), the movement of the lever arm 37, in rotation, from position A to position B, describing arc AB, forces the lever slot 35 to move upwards and the saw-toothed extractor 20, whose pin 27 is inserted in the lever slot 35, is also forced upwards in the cork pull-out direction.

As the lever arm 37 moves from position A to position B, describing arc AB, the saw-toothed extractor 20 also moves towards the frustoconical length of the rack 28 because as the saw-toothed extractor 20 move up, teeth 23 and 25 are displaced out of the chamber slots 3, 4. Simultaneously, as the lever arm 37 moves, teeth 26 of the saw-toothed extractor 20, dimensioned to fit the frustoconical length 30 of the rack 28, engage the frustoconical length 30 and force the rack to move upwards, in the pull-out direction.

Lever arm 37 rotation from position A to position B, describing arc AB, is easily done with a handgrip movement. Each time a handgrip force F_{HAND} 42, 44 is applied and the lever arm 37 rotates, the saw-toothed extractor 20 is lifted, engages the rack 28 and moves it upwards, in the cork pull-out direction. In the opposite direction, when the lever arm 37 rotates back from position B to position A (FIG. 10, FIG. 12) the saw-toothed extractor 20 is lowered and teeth 26 disengage from the rack. By repeating the application of the handgrip force F_{HAND} 42, 44 the repeated pull-out movement of the rack 28 forces the cork (fixed to the helical metal rod 32) out, opening the bottle.

Each time the handgrip force F_{HAND} is applied and released, the lever arm 37 rotates back to the original disengaged A position 42, 44 due to the action of torsion spring 38 (FIG. 8). Coil 39 of the torsion spring 38 is assembled inside notch 36 of the lever 33, whereas the legs 40 of the torsion spring lean along the side 40 (FIG. 10) of the tubular body and along the length 40 (FIG. 10) of the lever arm. If no force F_{HAND} 42, 44 is applied to the lever arm 37, the lever 33 remains in the open, disengaged position 42 (FIG. 10) and the rack 28 can translate along its axis and rotate.

Chamber 3, that encases rack 28, lever 33, and saw-toothed extractor 20, assembled in a tubular body 1, is covered by cover 12 (FIG. 2, FIG. 3). The interior of cover 12 (FIG. 12) is symmetric to the top part of the tubular body 1 and has the same geometry. Chamber slots 14, 15 in cover 12 (FIG. 2) are in symmetrical position and have the same dimensions as slots 4, 5. Slots 14, 15 in cover 12 also have the same function of slots 4, 5 in the top part of the tubular body 1. Slot 4, slot 14 and slots 5, 15 are dimensioned to fit tooth 23 on side wall 22 of the saw-toothed extractor 20, tooth 24 on side wall 21 of the saw-toothed extractor, and tooth 25 at the bottom of the saw-toothed extractor 20. All three teeth 23, 24, and 25 are on the back of saw-toothed extractor 20. Together, the top part of the tubular body 1 and the cover 12 encase the saw-toothed extractor 20 and the top part of the lever 33. Surface 16 in the interior side of cover 12 is cylindrical and symmetric to surface 2 in the top part of the tubular body. Together, cylindrical surfaces 2 and 16 encase rack 28 along its frustoconical length 30.

The top part of the tubular body 1 and the cover 12 are assembled together with three pins or three screws through holes 6, 7, 8 on the top part of the tubular body and holes 17, 18, 19 on cover 12. The pin or screw applied through hole 8 on the top part of the tubular body 1, and into hole 17 on cover 12, also passes through the hole 34 on the top part of the lever 33 creating a hinge. With cover 12 attached to the top part of the tubular body 1, chamber 3, saw-toothed extractor 20, and the top part of the lever 33, remain enclosed and protected and only the pins or screws at holes 17, 18, 19 are visible 45 (FIG. 13).

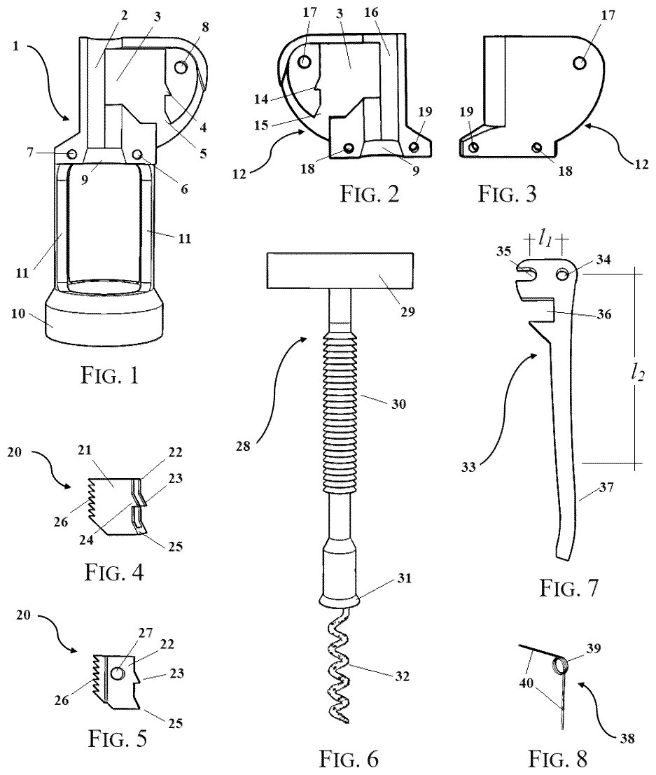

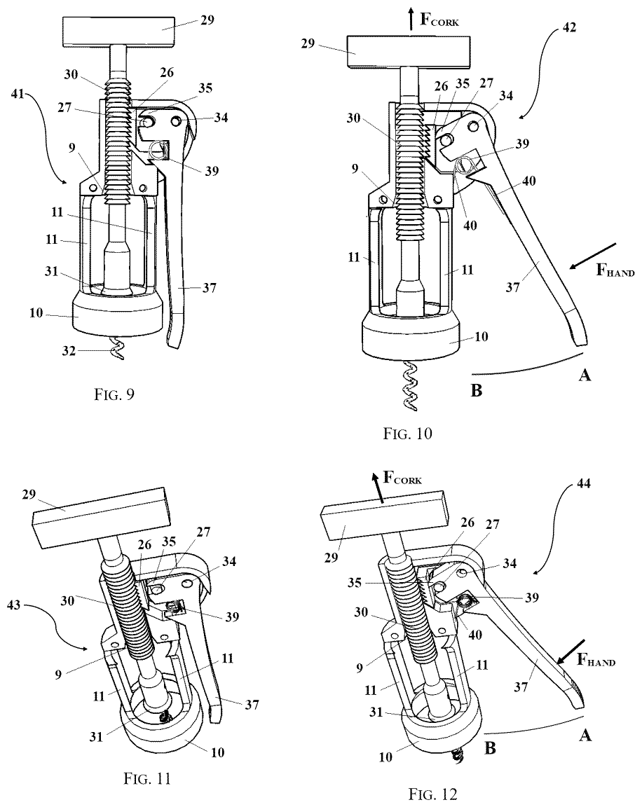

In the open, disengaged position 42 (FIG. 10), teeth 26 of the saw-toothed extractor 20, have no contact with rack 28 and it can move inside the cylindrical surfaces 2 and 16, in the top part of the tubular body 1 and in the cover 12, respectively. Inside the cylindrical surface defined by 2 and 16, the rack 28 can freely move (translate) along its axis and also rotate around its axis. The translation and rotation of the rack 28 allow the helical metal rod 32 to be easily inserted into any synthetic or natural cork by twisting the rack handle 29. The rack 28, nonetheless, although it can move along its axis (in translation), cannot be removed from the tubular body 1 when cover 12 is applied. If rack 28 moves in the downward direction with respect to the tubular body 1, the handle 29 will hit the top surface of the tubular body 1, 43, 44 and rack 28 will not slide further down into the cylindrical surface defined by 2 and 16. If rack 28 moves in the upward direction with respect to the tubular body 1, a small frustoconical protuberance 31 at its lower part will hit the frustoconical surface 9 (FIG. 1, FIG. 2) and the rack will be prevented from moving further up and from being removed out of the tubular body 1, 43, 44. The amplitude of the movement of the rack 28 inside the tubular body is, approximately, 2½ in (63.50 mm), which is more than sufficient to fully extract synthetic or natural corks, whose lengths usually vary from 1½ in (38.10 mm) to 2¼ in (57.15 mm).

In another aspect, alternatively, teeth along the rack 30 and teeth on the extractor 26 can be replaced by rough surfaces that allow the transmission of forces in the pull-out direction by friction.

In a further aspect, alternatively, two, three or more hinged levers similar to lever 33 can be used to apply the handgrip force.

In a further aspect, alternatively, the hinged lever 33 or levers can directly transmit the handgrip force in the pull-out direction without the use of extractor or extractors 20.

Although several aspects of the invention have been disclosed in the foregoing specification, it is understood that many modifications and other aspects of the invention will come to mind to which the invention pertains, having the benefit of the teaching presented in the description and drawings. It is also understood that the invention is not limited to the specific aspects disclosed, and that modifications and other aspects are intended to be included within the scope of the claims. Furthermore, although specific terms are employed above, as well as in the claims, they are used only in a generic and descriptive sense, and not for the purposes of limiting the described invention.

1. A corkscrew system comprising: a rack having a handle at one end, a helical metal rod at the other end, and teeth along part of its length; a set of one, two, three or more levers to transmit the force exerted by a hand grip to the direction of said rack; a set of one, two, three or more toothed extractors to engage said rack teeth and transmit the force exerted by a hand grip on said lever or levers to said rack; and a tubular body to house and guide said rack and to encase said toothed extractor or extractors and said lever or levers.

2. The corkscrew of claim 1, wherein said rack is equipped with axisymmetric frustoconical teeth along part of its length.

3. The corkscrew of claim 1, wherein said lever or levers are equipped with teeth and engage the teeth along the length of said rack directly, without the need for said toothed extractor or extractors.

4. The corkscrew of claim 1, wherein said lever or levers can be positioned in a disengaged, inactive position.

5. The corkscrew of claim 1, wherein when said lever or levers are positioned in a disengaged, inactive position, said rack is free to rotate and translate.

6. The corkscrew of claim 1, wherein said lever or levers can be positioned in an engaged, active position.

7. The corkscrew of claim 1, wherein while said lever or levers move from the disengaged, inactive position to the engaged, active position said lever or levers transmit a pull-out force to said rack axial direction and said rack simultaneously move along said rack axial pull-off direction.

8. The corkscrew of claim 1, wherein said tubular body is equipped with a frame and an annular structure to fit the neck of a bottle.

9. A corkscrew system comprising: a rack having a handle at one end, a helical metal rod at the other end, and rough surface along part of its length; a set of one, two, three or more levers to transmit the force exerted by a hand grip to the direction of said rack; a set of one, two, three or more extractors to engage said rack along the rough surface and transmit the force exerted by a hand grip on said lever or levers to said rack by friction; a tubular body to house and guide said rack and to encase said extractor or extractors and said lever or levers.

10. The corkscrew of claim 9, wherein said lever or levers are equipped with a rough surface and engage the rough length of said rack directly by friction, without the need for said extractor or extractors.

11. The corkscrew of claim 9, wherein said lever or levers can be positioned in a disengaged, inactive position.

12. The corkscrew of claim 9, wherein when said lever or levers are positioned in a disengaged, inactive position, said rack is free to rotate and translate.

13. The corkscrew of claim 9, wherein said lever or levers can be positioned in an engaged, active position.

14. The corkscrew of claim 9, wherein while said lever or levers move from the disengaged, inactive position to the engaged, active position said lever or levers transmit a pull-out force to said rack axial direction and said rack simultaneously move along said rack axial pull-off direction.

15. The corkscrew of claim 9, wherein said tubular body is equipped with a frame and an annular structure to fit the neck of a bottle.

16. A method of pulling-out synthetic or natural corks from bottles comprising the steps of: inserting a helical metal rod fixed at one end of a rack equipped with a handle at the other end into a cork inside the neck of a bottle by twisting and pressing the helical metal rod against the cork's top surface; and pressing a lever or more levers hinged at the top part of a tubular body repeatedly with a hand grip, from a disengaged position to an engaged position, as the circular bottom of the tubular body is supported by the neck of the bottle; and pressing and moving said lever or levers repeatedly with a hand grip with said lever or levers transmitting the force from the hand grip to said rack in the pull-out direction of the cork with the use of one or more extractors to transfer the force from said lever or levers to said rack; and repeatedly applying hand grip force to said lever or levers as the cork moves in the pull-out direction, said lever or levers being restored to the disengaged position by the action of one or more springs; and repeatedly applying the hand grip force to said lever or levers until the cork moves out of the bottle neck opening the bottle.

17. The method of claim 16, wherein said extractor or extractors are equipped with teeth and engage teeth along some length of said rack to transmit the handgrip force in the axial pull-out direction.

18. The method of claim 16, wherein said extractor or extractors are equipped with a rough surface and engage a rough surface along some length of said rack by friction to transmit the handgrip force in the axial pull-out direction.

19. The method of claim 16, wherein no extractor is used and said lever or levers are equipped with teeth and directly engage teeth along some length of said rack to transmit the handgrip force in the axial pull-out direction.

20. The method of claim 16, wherein no extractor is used and said lever or levers are equipped with a rough surface and directly engage a rough surface along some length of said rack by friction to transmit the handgrip force in the axial pull-out direction.
